(19) United States
(12) Patent Application Publication
(10) Pub. No.: US 2007/0271578 A1
(43) Pub. Date: Nov. 22, 2007

(54) System and method for tracking use of streaming media

(75) Inventors: Balaji S. Thenthiruperai, Overland Park, KS (US); Kevin E. Hunter, Olathe, KS (US)

Correspondence Address: SPRINT, 6391 SPRINT PARKWAY, KSOPHT0101-Z2100, OVERLAND PARK, KS, 66251-2100, US

(73) Assignee: Sprint Spectrum L.P., Overland Park, KS (US)

(21) Appl. No.: 11/437,894

(22) Filed: May 19, 2006

(51) Int. Cl. H04N 7/173; H04N 7/16

(52) U.S. Cl. 725/23; 725/1; 725/88; 725/102; 725/99; 725/112

(57) ABSTRACT

A system for providing pre-paid access to digital streaming media tracks a number of credits associated with each subscriber. The system measures subscriber use of a digital media stream by embedding frame indicators in the stream at periodic intervals. Each frame indicator includes a URL or other response address. The frame indicators may be inserted, for example, in an RTP header of the digital media stream. Subscriber devices, upon receiving frame indicators, send responses to the response address. With each response received from a subscriber device, the system decrements the number of credits available to the subscriber. The system may stop delivering the media stream to a subscriber who runs out of credits, until that subscriber purchases more credits.

### BACKGROUND

This invention relates to a system for providing streaming digital media. In particular, the invention relates to a system for tracking the use of such streaming media.

The use of streaming audio and video over the Internet is becoming increasingly popular, with Web sites devoted to presenting a wide variety of amateur content and often samples of professionally-produced content. The availability of professionally-produced content is limited, however, at least in part by the difficulty of obtaining revenue from the content. Possible revenue streams, such as advertising, have not proven to provide sufficient financial incentive to lead to extensive professional-quality video available in streaming digital format.

In other techniques of providing digital media, such as digital cable television systems, subscribers are often charged a regular fee for access to the digital system. The subscriber pays this fee in full even if he has not viewed much or any of the content provided during that pay period. Moreover, subscribers are, as a practical matter, tied to a particular provider.

Published U.S. Patent Application No. 2003/0061280 describes a system in which URL events are added to a media stream at configurable intervals, providing the ability to track the amount of time that a user has watched a particular event.

### SUMMARY

A system for providing pre-paid access to digital streaming media tracks a number of credits associated with each subscriber. The system measures subscriber use of a digital media stream by embedding frame indicators in the stream at periodic intervals. Each frame indicator may include a URL or other response address. The frame indicators may be inserted, for example, in an RTP header of the digital media stream. Subscriber devices, upon receiving frame indicators, send responses to the response address. With each response received from a subscriber device, the system updates the number of credits available to the subscriber. The system may stop delivering the media stream to a subscriber who has an insufficient number of credits.

### BRIEF DESCRIPTION OF THE DRAWINGS

FIG. 1 is a flow diagram of a method for tracking steaming media use, as performed at a media server.

FIG. 2 a flow diagram of a method for tracking steaming media use, as performed by a subscriber's media device.

FIG. 3 is a schematic block diagram of the functional architecture of a system for tracking streaming media use.

### DETAILED DESCRIPTION

### I. Overview of One Embodiment

In a system of tracking streaming media use, a media server keeps account information on various subscribers. Subscribers pre-pay or otherwise pre-arrange for a selected amount of access to the streaming content. For example, each subscriber may have a particular number of pre-paid credits recorded in an account. The media server sends streaming media content to a media device of a subscriber. The media device may be a personal computer, a media-capable mobile telephone or other mobile device, or a set-top box, for example. Billing frame indicators are periodically embedded into the digital media stream. These billing frame indicators include a network address, such as a URL (uniform resource locator) associated with the media server.

When the media device receives the media stream, it parses out the billing frame indicators and sends a response to the address provided in the billing frame indicator. The response indicates that the media device is currently making use of (e.g., displaying or storing) the media. When the response is received, the media server decrements the number of credits in the subscriber's account.

The media server determines the number of credits remaining in the subscriber's account, and if the subscriber has exhausted his credits, the media server can stop providing the streaming content to the subscriber.

### II. An Exemplary Method of Tracking Streaming Media Use

A. A Method Performed by a Media Server System

An exemplary method of providing streaming media content is illustrated in FIG. 1. In step 10, a media server system provides a media stream, such as a digital video stream. In step 12, the system inserts into the media stream a billing frame indicator associated with a particular subscriber, and in step 14, the system sends the media stream, with embedded frame indicator, to the subscriber.

The step 12 of inserting a frame indicator may be performed at preset, periodic intervals, such as every 30 seconds, or at other intervals. The intervals may differ depending on the content.

In step 16, the system receives a response from the subscriber, and, in step 18, the system updates data in the subscriber's account. To update the data, the system may, for example, decrement the number of credits attributed to the account. Based on the updated subscriber information, the system determines in step 20 the access rights permitted to the subscriber. In step 22, the system determines whether, based on the subscriber's access rights, to continue providing the media stream to the subscriber. If the system determines that it should continue providing access, then the process resumes in step 10 by providing the media stream. If the system decides not to continue access, then it initiates a shutdown or renewal request process in step 24. In this process, the system may, for example, simply stop sending the media stream, or the system may provide a message (which may itself be in the form of a media stream) that the user needs to purchase additional credits to continue viewing the media stream. If the subscriber provides payment (by credit card, for example), the system then increments the number of credits in the subscriber's account.

In variant embodiments, the system may operate to shutdown the media stream if it receives no frame indicator responses from the subscriber for a particular period. In case a series of frame indicator responses is mostly received, but one or more responses are missing, the system may perform an interpolation when updating subscriber data, to estimate the time the subscriber has spend making use of the media stream.

B. A Method Performed by a Media Device

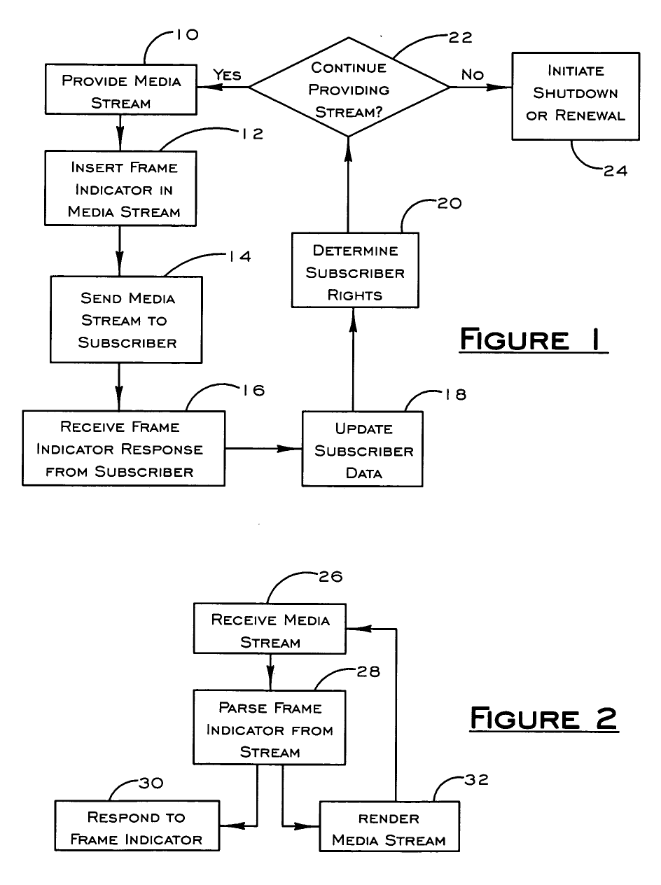

An exemplary method performed at the media device of a subscriber, such as a media-capable mobile telephone, is illustrated in FIG. 2. In step 26, the device receives the media stream, and in step 28, the billing frame indicator is parsed out of the media stream. In step 30, the media device responds to the sends a message in response to the billing frame indicator. In step 32, the media device renders the media stream by, for example, displaying video on a monitor and/or playing sound through speakers.

C. Examples of Billing Frame Indicators

A billing frame indicator includes a response address to which the media device is directed to send a response. The address may be in the form of an IP (Internet Protocol) address, a fully-qualified URL (Uniform Resource Locator), a relative URL, a URI (Uniform Resource Identifier), a SIP (Session Initiation Protocol) address, or other forms of address. The billing frame indicator may also include information that identifies the subscriber to which it is sent. For example, where the response address is a URI and/or URL that makes use of the generic URI syntax described in Internet Request for Comment (RFC) 3986 (January 2005), information identifying the subscriber may be located in the “query” segment of the URI.

The billing frame indicator may further include information identifying the media stream into which it is inserted, and it may additionally include information identifying the position of the frame indicator within the media stream (e.g., providing the number of minutes and/or seconds into the complete stream).

The billing frame indicator may be an HTML (HyperText Markup Language) tag, such as a tag in the form <IMG SRC=[URL]>, where “[URL]” is the response address. The tag may be a tag for a one-bit image, or a “Web bug.”

The billing frame indicator may be a “URL event” embedded in an ASF (Advanced Systems Format or Advanced Streaming Format) stream. The ASF format is described in, for example, U.S. Pat. No. 6,041,345.

In an embodiment in which streaming media is sent using RTP (Real-time Transport Protocol), the billing frame indicator may be inserted in an RTP header.

D. Responding to a Billing Frame Indicator

In an exemplary embodiment, the media device responds to the billing frame indicator by sending an HTTP GET message to the address specified in the billing frame indicator, including any information located in the “query” section of the address, if such information is provided. As an alternative, or in addition, the media device may generate its own information to include in the response message. For example, in some embodiments, the billing frame indicator does not include information identifying the subscriber. In such an embodiment, the subscriber's media device may add information to the response message, such as information identifying the subscriber. The media device may as appropriate add other information (not otherwise present in the billing frame indicator) to the response message, including information identifying the content.

### III. An Exemplary System for Tracking Streaming Media Use

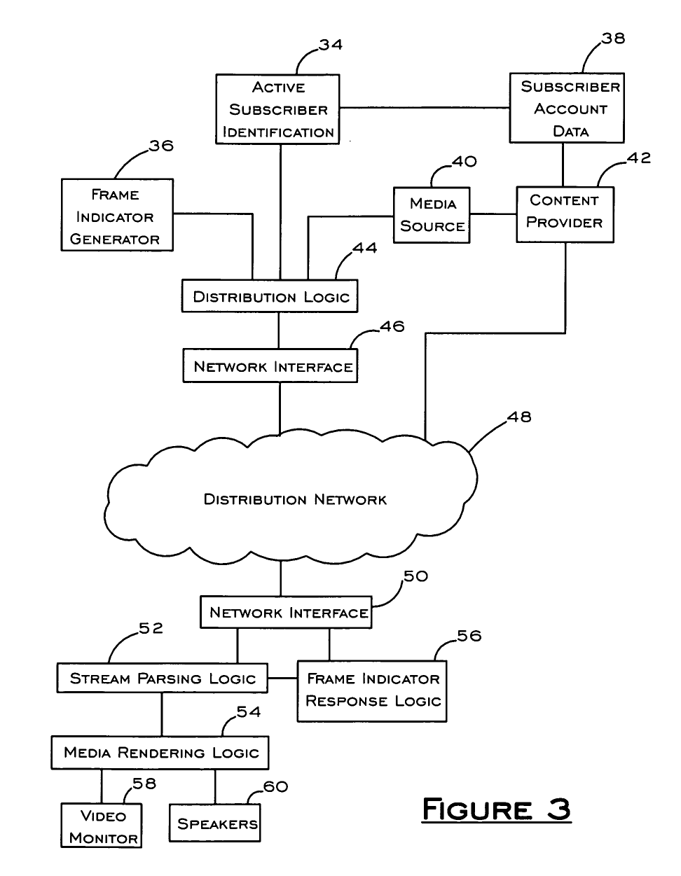

As illustrated in FIG. 3, a system for tracking streaming media use includes a network interface 46 associated with a media server and a network interface 50 associated with a subscriber. The media server and the subscriber communicate over a distribution network 48.

The media server is provided with a media source 40. The media source 40 may include media stored permanently by a media server, and/or it may include media supplied by one or more external content providers 42. Analogous to a cable television service, the media server may offer content from a variety of content providers 42.

The media server itself and/or one or more of the content providers is provided with a collection of subscriber account data 38, which may be stored in a database. The subscriber account data stores such information as, for example, password information, billing information, network and/or physical address information, and the number of credits remaining in a subscriber's account or accounts.

The media server is provided with distribution logic 44, which, in one embodiment, generates RTP packets for delivering media to one or more subscribers. Subscribers to whom media streams are currently being sent are identified in active subscriber identification data 34. The active subscriber identification data may be kept up to date with information from the subscriber account data 38 of the content provider 42. In one embodiment, the subscriber account data 38 keeps track of the number of credits available to a subscriber. If that subscriber runs out of credits, then the media server is directed to remove the subscriber from the active subscriber identification 34, or otherwise to provide an indication in the active subscriber identification that the subscriber is no longer to receive the media stream. In an embodiment in which the media server is operative to provide different content to different subscribers, the active subscriber identification 34 may include information identifying which media stream is being provided to which user.

The media server is further provided with a frame indicator generator 36. The frame indicator generator 36 creates the frame indicators that are periodically inserted into the media streams. The distribution logic 44 is operative to receive content from the media source 40, to insert the frame indicators from frame indicator generator 36 into the content, and to provide the content in the form of a media stream to the active subscribers through the network interface 46.

Media streams delivered over the distribution network 48 are received by the network interface 50 of an active subscriber's media device. The network interface could be a modem, such as a digital cable modem, and it may be implemented in a set-top box. The media device is provided with stream-parsing logic 52, which identifies the frame indicators in the media stream. The frame indicators (or the salient information therefrom) are provided to fame indicator response logic 56. The frame indicator response logic sends a response to each frame indicator. The response is preferably sent to an address (e.g., a URL) encoded in the frame indicator itself, or it may be sent to a default address or other address that was specified in advance (in an earlier frame indicator, for example). In a preferred embodiment, the address to which the frame indicator response is sent is an address associated with the content provider 42.

In a preferred embodiment, the distribution network 48 is the public Internet. In alternative embodiments, other networks may be used for all or part of the communications between subscribers and servers. In some embodiments, one network may be used for distribution of the media streams, whereas a different network is used to convey the frame indicator responses.

In an embodiment in which the subscriber's media device implements Web browser software, the stream parsing logic may include HTML parsing logic, and the frame indicator response logic 56 may make use of GET and/or POST requests.

A subscriber's media device is also provided with media rendering logic 54, which operates to convert the digital media stream into signals that may be rendered by a video monitor 58 and/or speakers 60. The media rendering logic 54 may operate to ignore any frame indicators in the media stream, or the stream parsing logic may remove frame indicators before the media stream reaches the media rendering logic. Alternatively, the media rendering logic 54 may make use of the frame indicators by providing an audio and/or visual indication that a frame indicator has been received (such as the brief, subtle flashing of an on-screen icon, or the incrementing or decrementing of a counter or bar graph.)

As described in section II above, frame indicator responses sent by a subscriber to a content provider 42. After receiving such as response, the content provider updates the subscriber account data 38 corresponding to that subscriber, preferably by decrementing a number of credits associated with that subscriber. If the subscriber runs out of credits, the content provider may cause the subscriber to be removed from the list 34 of active subscribers, or otherwise marked as inactive.

The embodiments described above provide different ways in which to implement the invention. The invention is not limited only to those examples, but rather is delineated by the following claims.

1. A method comprising:
providing a subscriber account and a quantity of credits associated with the account;
sending, to a subscriber associated with the account, streaming content including a frame indicator;
receiving a response to the frame indicator; and
as a result of receiving the response, updating the quantity of credits associated with the account.

2. The method of claim 1, wherein updating the quantity of credits includes decrementing the quantity of credits.

3. The method of claim 1, further comprising receiving payment from the subscriber, and increasing the quantity of credits as a result of receiving payment.

4. The method of claim 1, wherein the frame indicator includes a response address.

5. The method of claim 4, wherein the frame indicators include information identifying the subscriber.

6. The method of claim 4, wherein the response address is a URL.

7. The method of claim 6, wherein the frame indicator is inserted in an RTP header in the streaming content.

8. The method of claim 6, wherein streaming content is provided to at least two subscribers, wherein frame indicators are provided to the at least two subscribers, and wherein frame indicators provided to the at least two subscribers include different URLs.

9. The method of claim 1, wherein the frame indicator is inserted in an RTP header in the streaming content.

10. The method of claim 1, wherein the streaming content is digital streaming content sent using RTP.

11. The method of claim 1, further comprising:
determining whether the subscriber has exhausted its credits; and
discontinuing sending the streaming content if the subscriber has exhausted its credits.

12. The method of claim 1, wherein a plurality of frame indicators are inserted in the streaming content at periodic intervals.

13. The method of claim 1, wherein the frame indicators include information identifying the subscriber.

14. A method comprising:
sending streaming content to a subscriber;
while sending streaming content to the subscriber, sending a plurality of frame indicators to the subscriber; and
determining, based on responses to the frame indicators, whether to continue sending streaming content to the subscriber.

15. The method of claim 14, wherein the frame indicators are embedded in the streaming content.

16. The method of claim 15, wherein the frame indicators are embedded in the streaming content at regular intervals.

17. The method of claim 14, further comprising:
receiving responses to the frame indicators; and
updating a number of credits associated with the subscriber as a result of receiving the responses;
wherein determining whether to continue sending streaming content includes determining the number of credits associated with the subscriber.

18. The method of claim 17, wherein updating the number of credits includes decrementing the number of credits.

19. The method of claim 14, wherein each of the plurality of frame indicators includes a response address.

20. A system operative to:
store a number of credits associated with a subscriber;
embed a frame indicator into streaming content;
send the streaming content to the subscriber;
receive a frame indicator response;
update the number of credits as a result of receiving the response; and
determine, based on the number of credits, whether to continue sending streaming content to the subscriber.
